(19) United States
(12) Patent Application Publication
(10) Pub. No.: US 2014/0148923 A1
(43) Pub. Date: May 29, 2014

(54) APPARATUS AND METHODS FOR CONTROLLING LIGHT FIXTURES AND ELECTRICAL APPARATUS

(71) Applicants: Jose Luiz Yamada, Katy, TX (US); Mark E. Lewis, Waller, TX (US)

(72) Inventors: Jose Luiz Yamada, Katy, TX (US); Mark E. Lewis, Waller, TX (US)

(21) Appl. No.: 13/261,728

(22) PCT Filed: May 12, 2011
(86) PCT No.: PCT/US2011/000847

§ 371 Date: Sep. 3, 2013

Related U.S. Application Data
(63) Continuation-in-part of application No. 12/800,288, filed on May 12, 2010, now abandoned.

(51) Int. Cl. G05B 13/02

(52) U.S. Cl. CPC G05B 13/02
USPC 700/12; 700/295

(57) ABSTRACT

Apparatus and methods for monitoring and controlling the energy usage of an installation including lighting fixtures, motors, compressors, and other electrical appliances by monitoring the operating status of the electrical appliances, switching the electrical appliances on and/or off as mandated by operating conditions, intended use(s) of the installation, ambient conditions, energy consumption limits, and other factors, reporting the operating status of the electrical appliances to a system coordinator, storing information as to the operating status of each electrical appliance in the network to the memory of the system coordinator in a look-up table for subsequent retrieval as needed for operation of the installation, and transmitting a signal from the system coordinator that is operative to switch the electrical appliances on and/or off in accordance with the information stored in the look-up table.

The present invention relates to efficient allocation of energy usage in lighting and other systems including electrical appliances that is achieved by flexible control and two-way communication with the lighting fixtures or other appliances of the system. In more detail, the present invention relates to apparatus and methods utilizing point of use laser, infrared (IR), and/or radio frequency (RF) control of lighting fixtures or other appliances in which the control commands communicated to the fixtures and appliances do not necessarily elicit a particular response from the fixtures or appliances to which it is transmitted depending upon such factors as the time of day, the amount of ambient light, the number of other fixtures or appliances, and many other factors.

The need for energy efficiency has driven innovation in the development of lamps for light fixtures and control systems for lighting fixtures. Fluorescent fixtures have been retrofit to many buildings in place of metal halide fixtures to reduce energy consumption. Although fluorescents have been improved by development of so-called T5 or T5HO fluorescent lamps and “quick start” ballasts and ballasts with electronic controls and significant energy savings have been achieved as a result of such developments, the improvement achieved by development of such lamps and ballasts has been only incremental over the many years that fluorescents have been in widespread use.

Remote switching systems are available for switching a ceiling fan and/or light in a room or building. So far as is known, however, systems capable of distinguishing between multiple electrical appliances are characterized by operational limitations, complication, and/or high installation cost. One such system is available from Sensor Switch, Inc. (Wallingford, Conn. and Port Perry, Ontario, www.sensorswitch.com), which markets a so-called “Hospital Bed Light Controller” that is retrofit to existing “pull chain” hospital bed wall lights and operated by an infrared (IR) receiver/controller and an IR transmitter with a range of 8-10 feet. The advertising for the Hospital Bed Light Controller claims that a nurse with one remote can control all the wall lights on the ward or floor of the hospital. Though useful for a small room, the range limitations of this system do not allow for effective use unless the operator is close to the wall lights.

U.S. Patent Publication No. US2005/0025480 describes a laser-activated photoresistor for on/off switching, but a photoresistor is too slow acting for many applications and merely switches on/off with no operating flexibility. Further, the laser-activated photoresistor is susceptible to ambient light such that switching can occur as a result of, for instance, a flashing light or even incident sunlight. The slow response of the photoresistor severely limits the useful range of the remote for this system due to incremental laser movements resulting from shaking or natural movements in hand held operations. U.S. Pat. No. 6,252,358 (and many other systems) use radio frequency (RF) control to switch fixtures, but such systems are complicated and therefore not well suited for use in commercial installations in which many fixtures must be controlled. Further, RF systems are not targeted to specific fixtures and/or individual lamps or groups of lamps such that in the absence of encoding of the RF signal (and the resulting complexity of operation), fixtures are switched that are not intended to be switched.

U.S. Pat. Nos. 4,897,883 and 6,828,733 disclose handheld IR transmitters said to be capable of switching individual fixtures. However, the systems described in those patents utilize encoded IR signals and pre-programmed, separately addressable IR receivers mounted to the fixtures controlled from the handheld transmitter to switch the fixtures, requiring increased operational complexity and cost of installation, especially in installations with many fixtures. So-called DALI (digital addressable lighting interface) systems are available (for instance, from Specialized Lighting Solutions, Beaverton, Oreg., and Complete Technology Integrations Pty Ltd, North Ryde, NSW). Although impressive in their capabilities and operational flexibility, such systems are expensive to purchase and install, may require specialized programming or re-programming when changes are needed in a particular installation, and are operationally complex. Other systems require calibration processes at the time of installation and complex operating instructions that are programmed into a central controller such that they cannot be operated by anyone other than trained operators and must be re-programmed, often requiring on-site visits by the installer, when changes are made in the manner in which the space lighted by such systems is used for a different purpose.

Many existing controls elicit a specific response for a specific command. Therefore, by using existing control systems, large groups of fixtures can be turned on or off as a response to an on or off command. Some such systems control groups of fixtures that are on the same circuit. This method is fast, but lacks the ability to customize the control of fixtures on the same circuit, thereby losing possible energy savings from customization. By using technology such as DALI, custom lighting arrangements can be achieved through issuance of commands to individually addressed fixtures or ballasts. RF wireless networks that have the capabilities of addressing commands to an individual appliance through an addressable RF module are also available. Although wireless, these systems have similar operational limitations as DALI. They are characterized by the complexity of programming, commissioning, and operation and have longer response times for customized settings when controlling large numbers of fixtures.

Another problem that has arisen has been created by financial incentives and/or regulatory requirements of energy conservation and consumption. Many public utilities offer favorable rates and other incentives to power purchasers, especially large purchasers, that agree to limit consumption during times of peak demand and/or that agree to decrease consumption upon receipt of notification from the power producer and/or carrier. Further, electrical rate charges for commercial purchasers are sometimes based on peak consumption such that a purchaser may be able save money by decreasing peak consumption and tax incentives are also offered to some purchasers. In some areas, power consumers are actually limited in the amount of electricity, or load, they can utilize at any given time. All of these supply, contract, and/or governmental factors act as incentives for limiting and/or reducing consumption and create a demand for control systems capable of reducing total and peak power consumption, and it is an object of the present invention to provide such systems.

It is also an object of the present invention to provide a system for controlling lighting fixtures and other electrical appliances that is capable of documenting, or verifying, that power consumption has been limited and/or reduced as required for such purposes as qualifying for favorable electrical rates and/or tax incentives.

Another object of the present invention is to provide an apparatus for monitoring the operational status of the fixtures in a lighting system for maintenance planning and/or to switch different lamps and/or fixtures on or off in the event inappropriate readings that might indicate failure or other problems are reported from a fixture.

Another object of the present invention is to provide an apparatus and method for controlling lighting fixtures and other electrical appliances that reduces, and in some instances, even eliminates the need for operator intervention for some inputs that affect operating status by providing a set of operating rules that are implemented by a controller for, for instance, over-riding a signal from an ambient light sensor that is received during night-time hours such that essential night-time lighting is not switched off.

Another object of the present invention is to provide a lighting control system, and a system for controlling other electrical appliances, in which the lighting fixtures and/or electrical appliances respond to signals from a hand-held remote control, external inputs that do not require operator intervention, or a system controller in accordance with a pre-programmed set of operating rules so that a simple commands such as “select operating state 6” can be used to control some or all the fixtures and/or appliances in the system.

Another object of the present invention is to provide a lighting control system, and a system for controlling electrical appliances other than lighting systems, in which multiple fixtures and/or appliances can be set to a selected operating state (“select operating state 6”) in accordance with pre-programmed operating rules and/or by an operator that then assumes subsequent operating states in accordance with the pre-programmed operating rules in accordance with certain external inputs, for instance, the system assumes “operating state 7” at 7:00 am and/or, if system power consumption is limited and certain ventilating fans, for instance, that are included in the system are switched on by an operator while the system is in “operating state 7,” selected lighting fixtures (selected by the pre-programmed operating rules) are switched off so as to maintain system power consumption below the system limit.

Another object of the present invention is to provide a control system for lighting and other electrical appliances that is “self-learning” in that individual fixtures and/or appliances can be set to desired operating status by an operator and their operating status sampled and saved by a system controller for recall in accordance with pre-programmed operating rules and/or at the operator's command to cause individual fixtures and/or appliances to assume the operating status to which the fixtures/appliances were set.

Another object of the present invention is to provide a method and apparatus that switches electrical appliances to limit consumption in accordance with pre-programmed rules for insuring compliance with conservation, financial, and/or regulatory incentives for efficient power consumption, reduction of peak consumption, and/or conservation.

Another object of the present invention is to provide a system for switching electrical appliances in a wireless or wired control network as described in co-pending International Application Nos. PCT/US2009/001734, MODULAR, ADAPTIVE CONTROLLER FOR LIGHT FIXTURES, filed Mar. 19, 2009, and PCT/US2009/005272, POINT OF USE AND NETWORK CONTROL OF ELECTRICAL APPLIANCES AND METHOD, filed Sep. 22, 2009, both commonly owned with the present application.

This listing of several objects of the present invention is intended to be illustrative, and is not intended to be a complete listing of all objects of this invention; instead, this listing of several objects of the present invention is intended to be illustrative in the sense that the invention addresses many needs and solves many problems, not all listed here. Other objects, and the many advantages of the invention, will be clear to those skilled in the art from the detailed description of the embodiment(s) of the invention and from the drawings appended hereto. Those skilled in the art will recognize, however, that the embodiment(s) of the present invention described herein are only examples of specific embodiment(s), set out for the purpose of describing the making and using of the present invention, and that the embodiment(s) shown and/or described herein are not the only embodiment(s) of a control system for light fixtures and other electrical appliances constructed in accordance with the present invention.

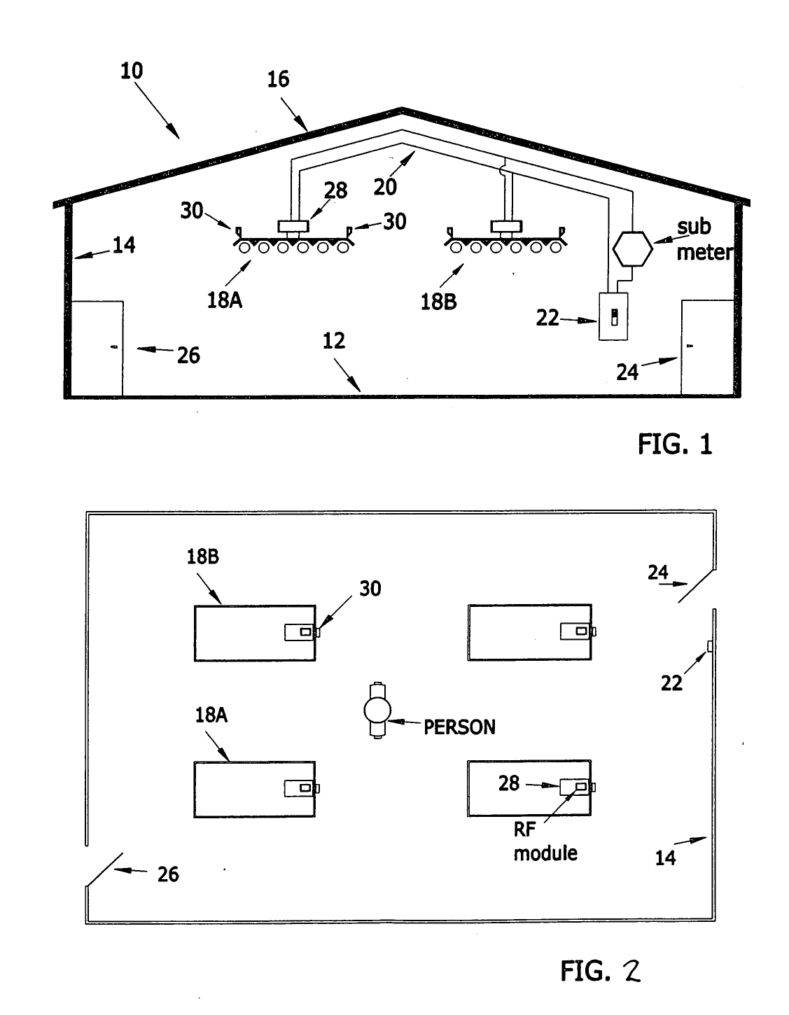

Referring now to the figures, FIG. 1 shows a diagrammatic view of an open-frame building with high bay lights installed and wired in a manner commonly utilized in which the method and apparatus of the present invention is advantageously installed.

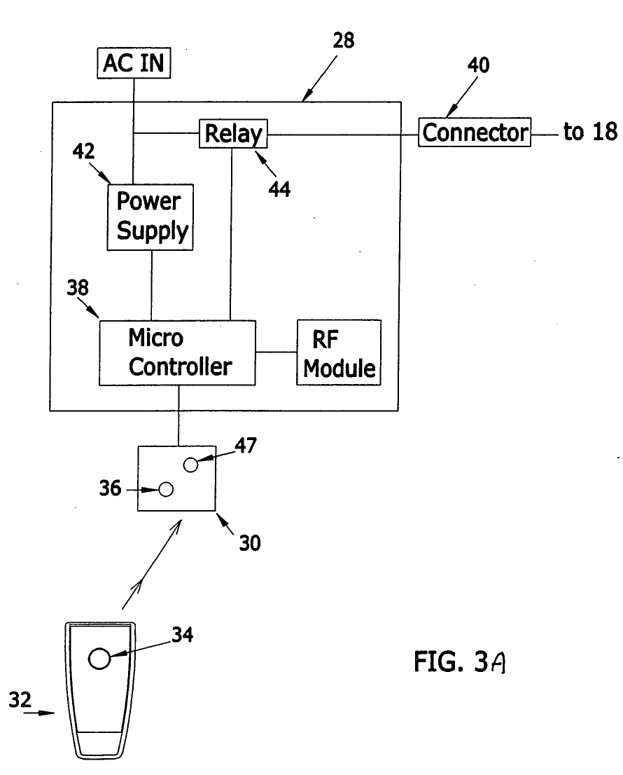

FIG. 2 shows a plan view of the building of FIG. 1.

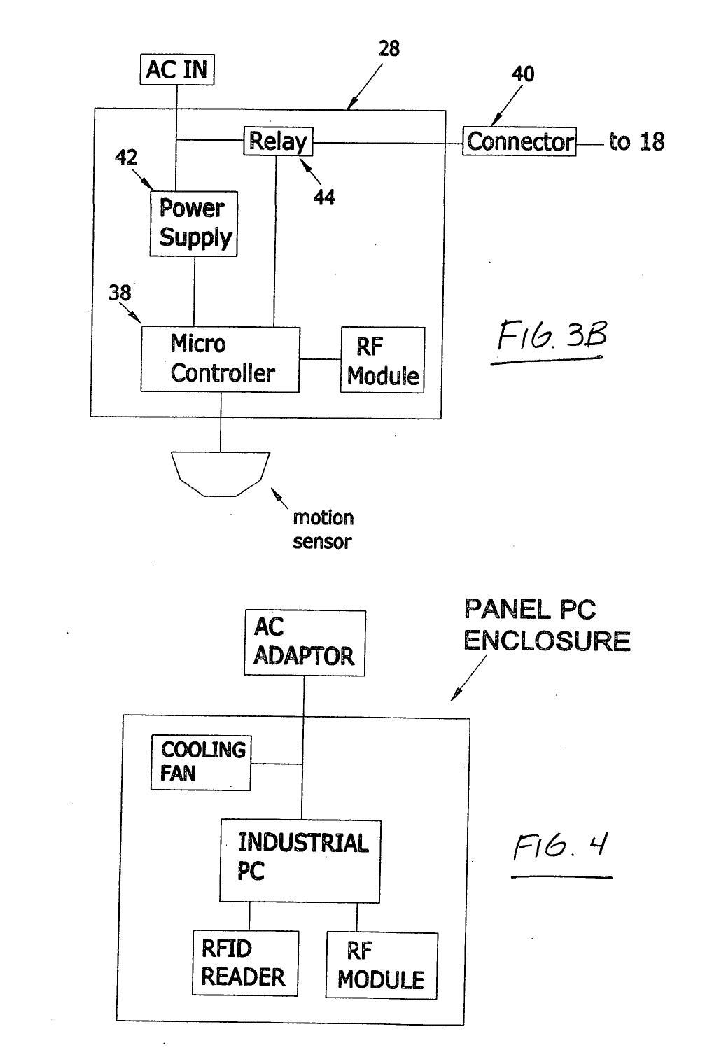

FIGS. 3A and 3B are schematic views of two embodiments of a switch controller comprising the apparatus of the present invention.

FIG. 4 is a schematic view of one embodiment of a system coordinator for a lighting system constructed in accordance with the teachings of the present invention.

FIG. 5 is a diagram showing one embodiment of logic of the switch controller shown in FIGS. 3A and 3B.

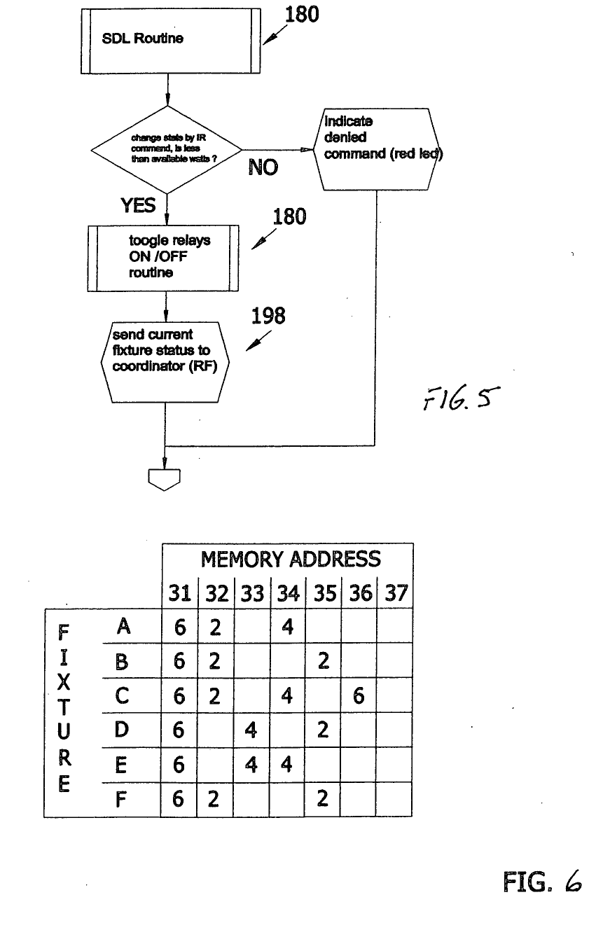

FIG. 6 is a schematic diagram of a data table illustrating one way to organize the operating rules stored in the memory of the controller of FIG. 4.

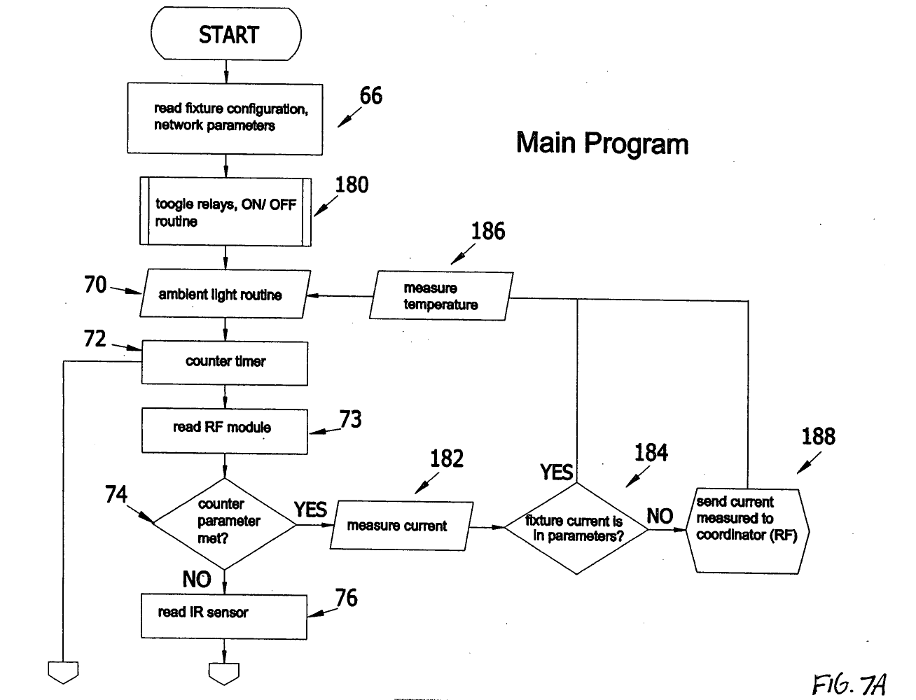

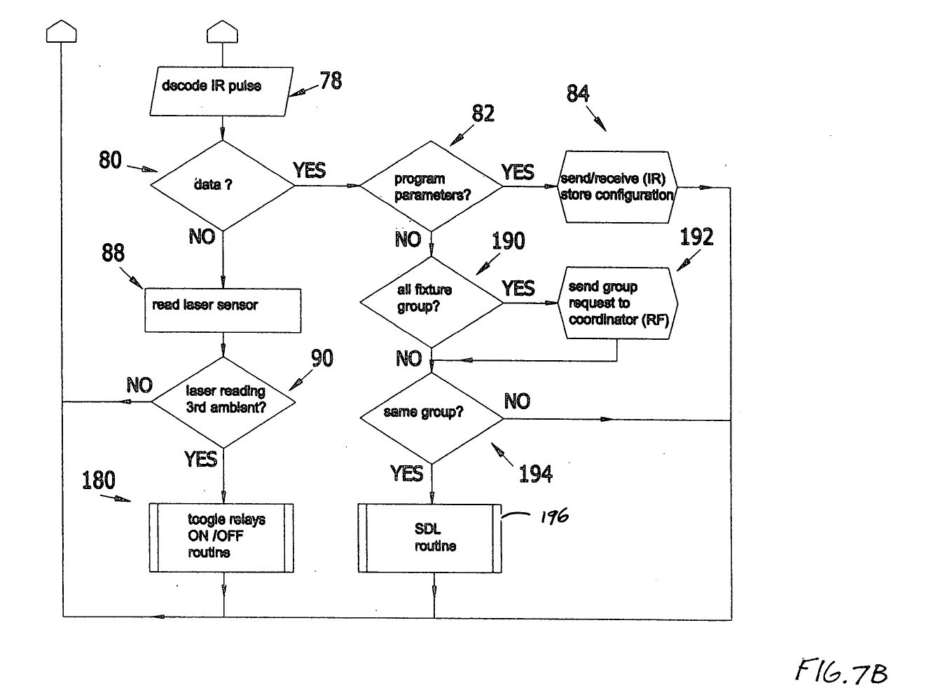

FIGS. 7A and 7B are schematic diagrams illustrating one embodiment of the control logic of the main program of the present invention.

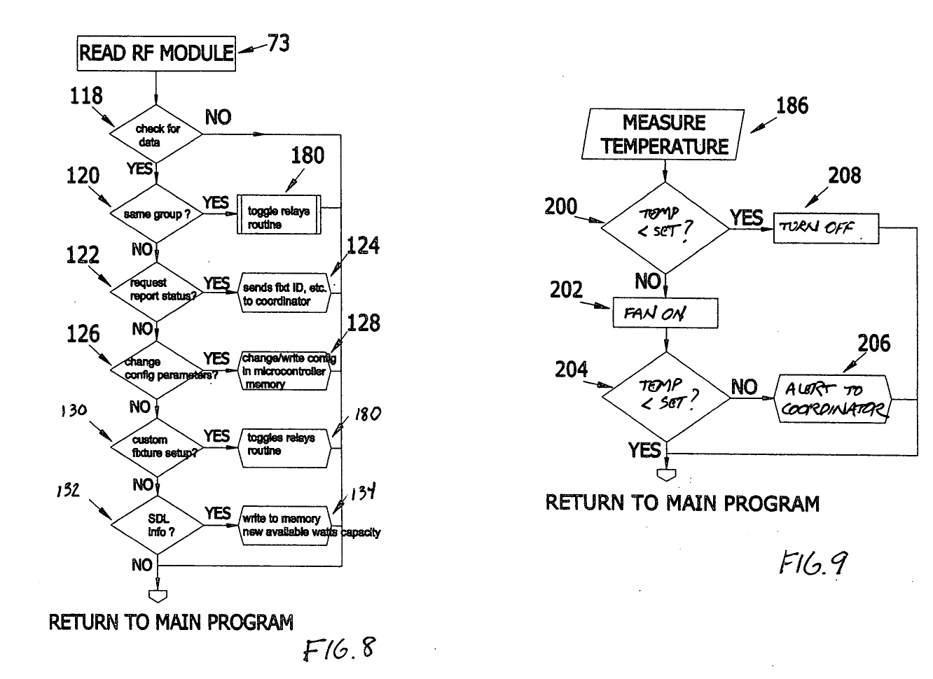

FIG. 8 is a schematic diagram of the control logic for the RF module of the main program illustrated in FIG. 7.

FIG. 9 is a schematic diagram of the control logic for the temperature module of the main program illustrated in FIG. 7.

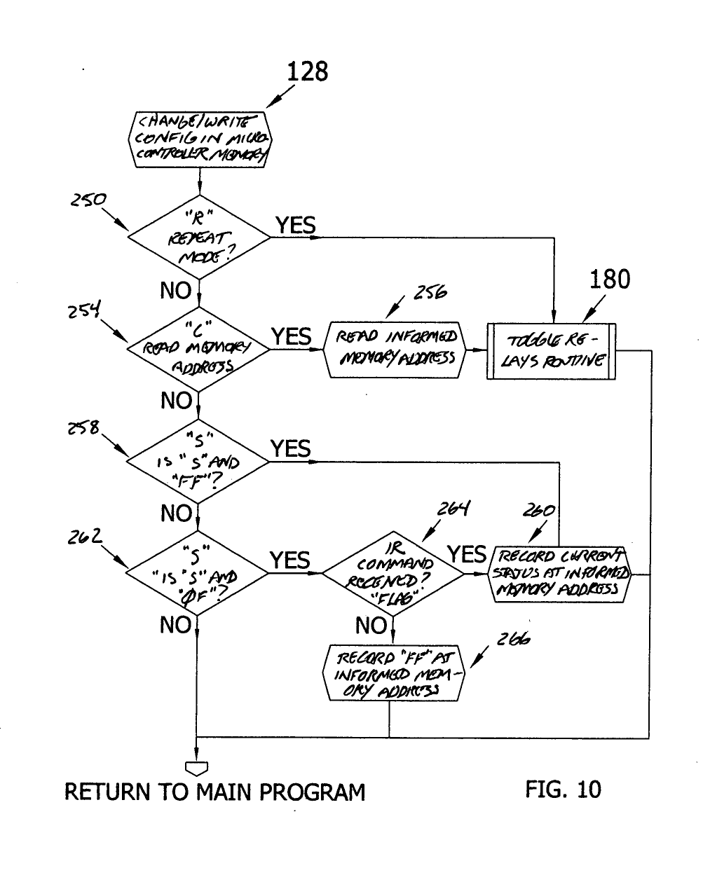

FIG. 10 is a schematic diagram of the control logic for the selective point of use group affiliation subroutine that enables the operator to customize the operating status of multiple groups of fixtures (or other electrical appliances) in a network.

The present invention provides what is referred to herein as Smart Demand Limits (SDL). This feature allows authorized system users to set consumption and demand limits for the energy use of devices controlled by the system. This limit can be changed by an authorized administrator as a response to, for instance, changes in building use or incentives for energy conservation. Many such governmental and energy company incentives exist, such as EPACT, to encourage installation of energy saving lighting systems capable of reducing consumption as well as, demand during peak demand emergencies. This feature allows for the allocation of lighting in areas where it is most needed by limiting consumption in areas of less need through the individual step dimming controls of the present invention. Upon determination of the maximum wattage available at a given time, the method and apparatus of the present invention limit consumption in accordance with the following method.

A system coordinator, shown schematically in FIG. 4 and described in more detail below, monitors energy consumption based on the rated consumption of the lamps (54 watts for each T5HO, for instance) or through the actual measured system consumption by either a power submeter (such as Electro Industries Shark 100) that reports energy use or through a current sensing devise placed in each individual fixture. For the purpose of illustration, and using the rated power consumption method, if the particular installation in which the lighting system is installed is a manufacturing building of 20,000 square feet (sf) that must achieve a lighting power density of 0.55 Watts per sf, the building would need to limit electrical consumption to 11000 watts per hour or 203 T5 HO lamps in order to comply with the needed efficiency standard. If the building is equipped with 40 T5 6-lamp fixtures with a potential power consumption of 12960 watts (if all lamps are operating), the Administrator sets 203 lamps as the Smart Demand Limit. During manual or automatic operation, each fixture/switch controller has recorded to memory the last coordinator generated balance (203 minus 200 in use=3 available balance) of lamps available to the system. If the available balance is greater than an operator-requested IR remote command (switch two lamps on, for instance) the fixture controller allows the execution of command and communicates to the coordinator to switch two additional lamps on. The coordinator adds to lamps in use and subtracts from total available to generate a new available balance (203−202=1), then broadcasts the new balance to the network for recording to the memory of each fixture. As each individual fixture changes state of operations, it anticipates the expected response from the coordinator. If the response is not received during an allotted period of time, the fixture re-sends the reported usage and again awaits the expected response. The communication is broadcast throughout the network and each fixture updates the available balance. In the absence of an approved coordinator response, each of the fixtures returns to its previous and lower state of operation.

A repeater, or point of use network control, feature is limited to prevent exceeding the pre-selected limit for the installation. In this example, each fixture only executes repeater commands up to four lamps, therefore effectively limiting system use in that modality to 160 lamps. Each receiver is equipped with a target green LED that serves both as a target and an indication that there is available capacity in system and a red LED that is energized when the SDL ceiling is reached. The operator must then shed demand in another area to free up capacity in the desired area. Through this and other logic steps, the system prevents inadvertent or intentional power consumption that exceeds the established limits. Rules are operative in the individual fixtures as well as in the coordinator and are therefore enforced even in the absence of a properly functioning coordinator. When using actual measured consumption, either by submeter or current sensing devise on individual fixture, controls operate on the same logic, i.e., Max watts=11000−Current Usage 10,000 watts=1,000 watts available.

The advantages of this new level of control are far reaching. As a result of the SDL routine 196 (see FIG. 7B), all custom programming of the self learning features comply with established system limits. By means of a System Use Documentation procedure, data is compiled on the operation of each set of lamps in each fixture for the purpose of continual improvement in measured performance and for such purposes as validating manufacturer's warranties and documenting compliance with governmental regulations and incentives and/or power distributor incentives and/or restrictions. This feature also allows for the maximization of the useful life of the lamps and other components, thereby reducing the impact of equipment disposal on the environment.

In a second embodiment, the present invention provides what is referred to herein as a Custom Response Feature that allows for rapid control of many fixtures, each going to a custom setting (that may be different from other fixtures wired in the same circuit) upon issuance of a single command. In seconds, thousands of fixtures can go to individually customized settings on a single command from the centralized controller or with a point of use remote transmitter. This feature allows for maximum energy savings through custom lighting arrangements and can extend the useful life of the equipment, thereby reducing the environmental impact of premature equipment disposal. The advantages of this enabling technology are far reaching. For example, on a single command, hundreds of luminaries can be dimmed, HVAC systems load reduced, or exhaust fans slowed as an immediate, appliance-specific, custom response to a single demand response command. Another advantage of this new method is ease of programming, commissioning, and change of custom settings as a response to environmental changes, facility use changes, or for normal lumen degradation of luminaries. This capability addresses major problems associated with the commissioning and operation of systems with daylight harvesting, occupancy or vacancy sensing, and other forms of control inputs. A common problem with existing lighting systems and controls is that the programming and commissioning of the system is so complex that users bypass the controls to operate the fixtures manually. When they do so, intended energy savings are lost because the operator(s) are unable to adjust, calibrate, and re-commission the system. This Custom Response Feature, which works through a process of data storage and logic that is fixture controller centered, solves this problem.

In one embodiment, this Custom Response Feature is implemented by switching individual fixtures/appliances to optimize lighting and energy savings through point of use or centralized control. The operating state and other data of each fixture/appliance records to a specific memory address on command originating from a centralized controller (coordinator) or hand-held transmitter with programming capabilities. During automatic control, the control command for each fixture is read and the data stored at a specified memory address. Each fixture controller reads, interprets, and executes based on the data recorded at that specific memory address. An example of the resulting simplicity and effectiveness is shown by a custom setting that safely and immediately reduces consumption for peak demand response, If, for instance, an installation has contracted with a utility to shed 50,000 watts of peak demand on instruction, that decrease in consumption is achieved, for instance, by dimming fixtures to a level that achieves the reduction without compromising safety (and/or by reducing the speed of ventilating fans or other appliances) to a level that achieves the reduction called for by contract. The system user sets the lighting at the desired safe level, sets other appliances at energy saving settings, and issues the command for the fixtures/appliances to record the settings to a specific memory address, for instance, address D1. Upon subsequent receipt of the Demand Response Command (DRC) from the utility company or governmental agency, the system issues the Custom Response Feature command “read D1,” and each fixture/appliance reads the data found at that memory address and responds accordingly, and the facility safely sheds the required demand within seconds. Of course those skilled in the art will recognize from this disclosure that other situations may be present in which it is useful to issue a DRC such that in one embodiment, multiple DRCs for use in multiple circumstances and/or operating conditions (for instance, a “lamps full on” DRC upon receipt of an input from an electronic security system), each causing individual lamps and/or fixtures in the network to switch on, switch off, or maintain their current operating state, are stored in the memory of the system coordinator. Calibrating or re-commissioning is achieved by making changes to the operating state of individual fixtures in the network and then issuing a new command to store data to D1, overriding the previous recorded data at that address, or to other DRCs stored in memory.

Calibration and re-commissioning is an important aspect of lighting system design and the present invention is utilized to particular advantage for these processes, and can be done by different operators and at different levels, with testing and compliance at each level. Calibration and commissioning uses point of use control and experiential measurements for each level of decision makers/operators. For example, the lighting designer, building owner, tenant, safety manager, sustainability manager, and other personnel may all have input as to the lighting needs (or the needs of other electrical systems) for a particular installation, and the programmer can make changes at the point of use that can be immediately evaluated for safety concerns, operational preferences, and such issues as whether energy savings objectives/limitations are met.

An additional aspect of the present invention is the ability to establish group affiliations in control programming from point of use. In facilities where there are a large many fixtures, or in facilities where there are dynamic controls during operation, i.e. motion sensing, daylight harvesting, etc., broadcasting the standard custom programming command to all fixtures may present difficulties because the fixtures may switch during the programming process such that undesired configurations could be recorded to memory. Using the programming hand-held transmitter 32 (see FIG. 3A) of the present invention, the user sends a command that sets the desired operational state for the desired fixtures and also alerts the switch controller 28 (see FIGS. 3A and 3B) on the fixture to be on stand-by for a selective broadcast custom programming command. Upon receiving this command “0F” from the coordinator, or the programming hand held transmitter, the selected fixtures record current state to the selected memory location. Other fixtures in the network record a default “FF” in the memory location, signifying no action or change of state required. The “0F” stand-by command and the “FF” default command may be combined with, for instance a read (“R”) command and a set (“S”) command, the combination of the “S” and “0F” commands, for instance, followed by receipt of a command from the hand-held infrared transmitter, raising a “flag” at the particular fixture that then causes that fixture to respond by recording its current operating status at an informed memory address. If no IR command follows the flag, the default “FF” is recorded at the informed memory address without any change in operating status. Those skilled in the art will recognize from this disclosure that other operating rules may likewise be programmed into the coordinator and/or the switch controller located on the fixtures. For instance, a group of two, six, or any other number of fixtures in the network can be set to stand-by in this manner while the operating status of other groups of fixtures in the network are set to respond to other subsequent broadcast commands and/or continue to respond to dynamic external inputs. By this means, effective group affiliation is possible in a method that is safe and very effective. With this method, a practically unlimited number of group affiliations can be established easily and effectively.

Referring to the figures, FIGS. 1 and 2 show schematic drawings of an open bay building 10 including a lighting system of a type with which the present invention is used to advantage. The lighting installation includes lighting fixtures 18A and 18B (shown as six-lamp fluorescent fixtures, but those skilled in the art will recognize that the fixtures can be any type of fixture), having respective switch controllers 28 mounted thereto. Fixtures 18A and 18B and their respective controllers 28 are wired into a circuit 20 that includes a coordinator 22 and separate submeter. An open bay building is shown here for purposes of illustration, it being recognized that the invention is limited to that application. Similarly, it will be recognized that the invention is not limited to systems including fluorescent fixtures (as set out herein, the present invention is also suitable for use in connection with electrical appliances other than lighting fixtures). As shown in FIG. 2, the lighting installation may include four fixtures 18, each with respective switch controllers 28, each switch controller 28 including a transceiver in the form of an RF module electrically connected to the respective switch controller for detecting a signal from an external input and transmitting a signal from the fixture 18 indicative of the operating status of the fixture 18 to switch controller 28 upon detection of a signal from an external input.

Referring to FIGS. 3A and 3B, two embodiments of switch controller 28 are shown schematically. The first embodiment (FIG. 3A) includes a target 30 that includes a target LED 36 at which the laser or infrared hand-held remote 32 is aimed, the button 34 on remote 32 producing an encoded signal that is detected at target 30, and an indicator LED 47 that provides visual confirmation of receipt of a signal from remote 32. The second embodiment (FIG. 3B) substitutes a motion sensor for the target module 30 for detecting a passing vehicle or person and producing an output that is detected at microcontroller 38 of switch controller 28 to cause certain action in accordance with operating rules that are pre-programmed into the memory of microcontroller 38 through operation of relay 44, which is connected through connector 40 to one or more of the lamps of fixture 18.

FIG. 4 is a schematic diagram of a system coordinator that may be, for instance, mounted on the wall 14 of building 10 (FIG. 1) for use with the lighting installation. The coordinator includes a dedicated computer, for instance, a touch screen computer (labeled as an industrial PC in the figure), cooling fan and AC adapter, panel PC adapter to facilitate wall mounting, and in addition to the touch pad, such inputs as an RFID reader and an RF module. The latter includes send and receive functions for communicating via RF to the fixtures 18 in the installation and the former is an input that, in much the same manner as the motion sensor shown in FIG. 3B, causes the coordinator to issue a command upon detection of an RFID tag (passive or active) that causes the fixtures 18 to switch on, off, or do nothing in accordance with pre-programmed operating rules stored in the memory of the coordinator. Further, the command issued by the coordinator may vary in accordance with the particular RFID tag detected by the RFID reader such that upon detection of an RFID tag carried by, for instance, a security guard, light fixtures switch on in a dark warehouse so that the security guard can safely make the rounds of the appointed checkpoints of the installation or a shift worker who arrives at the installation in the morning and needs lights switched on at a work station for performance of work duties. Of course the same coordinator may have several sets of commands stored in memory in accordance with pre-programmed operating rules such that multiple shift workers, each carrying their own RFID tag, may be detected at the coordinator and light fixtures switched on/or off in accordance with the operating rules.

The control logic for the operating software for the microcontroller 38 of each switch controller 28 is shown in FIG. 5 and the description of that logic set out in the above-incorporated prior applications is referenced for the details of that logic. FIG. 6 illustrates a look-up table corresponding to the fixtures A-F in the installation with memory addresses 31-37 being illustrated and the number of lamps to be switched on in each fixture being set out in the table in accordance with the pre-programmed operating rule stored at each respective address in the memory of the coordinator.

FIGS. 7A-7B, 8, and 9 illustrate the control logic for the operating software for the main program (FIGS. 7A-7B) and subroutines for input from the remote 32 or coordinator (FIG. 8) and an external input such as a temperature sensor for regulating the temperature of the ballast in the fixture 18 (FIG. 9), each in accordance with the detailed description of that logic set out tine in the above-incorporated prior applications. In the particular embodiment shown in FIGS. 7A and 7B, the control software includes software for dimming a light fixture in which multiple lamps are mounted as implemented by the toggle relays on/off routine 180 described above. In the next step, the output from ambient light subroutine 70 described in the above-incorporated prior applications is read and counter/timer 72 is checked. If the counter parameter is met as at step 74, current is measured at step 182 (for instance, by sampling the output from a current sensor (not shown) and determining whether current is within the user-selected parameters at step 184. If fixture current (or the current drawn by the load switched in accordance with the present invention) is within user-selected operating parameters, temperature is measured at step 186 by sampling a temperature sensor (not shown) and the method cycles through counter/timer 72 until the counter parameter is not met, after which the output from the IR sensor(s) is read at step 76. If fixture current is not within user-selected operating parameters at step 184, the current measurement from the current sensor is sent as at step 188 to the coordinator, temperature is measured at step 186, and the method cycles through counter/timer 72 as described in the preceding sentence.

If data read at step 76 by the IR sensor(s) is an IR pulse that can be decoded as at step 78 such that data is present at step 80, data is checked 82 to see that it meets program parameters. If program parameters are met, microcontroller 38 sends and/or receives and stores configuration data to memory 84 and the method cycles back through counter/timer 72. If user-selected parameters are not met at 82, the program queries 190 all fixtures in a group (as selected and identified by user input) and sends a group request to the coordinator 192 or ascertains whether the decoded IR pulse is for the same group at step 194. If not for the same group, the method cycles back through counter/timer 72 as described above. If for the same group, the output from the SDL routine is sampled at step 196 and the method cycles back through counter/timer 72.

Referring to FIG. 8, a subroutine 73 for reading the output from an RF module (not shown) commences with a check for data 118; if no data is present, the subroutine returns to counter parameters query 74 of the controller main program as described above and shown in FIG. 7. However, if data is present, the RF module subroutine 73 checks 120 to determine whether the data specifies the same group of fixtures to which the controller is mounted, in which case the subroutine 73 checks the toggle relays routine 180 as described below. If the data at step 120 is not data for the particular group to which the controller belongs, subroutine 73 continues by determining whether the data is calling at 122 for a report of the status of the fixture to which the controller is mounted. If the data is a call for a status report, the subroutine 73 sends the identification code for the fixture, fixture status, and other functional information to the coordinator as at 124. If the data is not a call for functional information, the subroutine 73 then determines whether the data calls for a change in the configuration parameters of the fixture to which the controller is mounted, for instance, a change in cooling parameters as exemplified at step 126, in which case the changed configuration is stored to the memory of the microcontroller 128. Subroutine 73 continues at step 130 by checking to determine whether a custom fixture setup, or operating rule, is stored in system memory, in which case the toggle relay routine is entered as at step 180. If no such stored information is available, the subroutine continues by checking for smart demand limit (SDL) information or rules output from SDL routine 196 (see FIG. 7B) at step 132. If no such information is available, the subroutine exits to the main program (FIG. 7); if such information is found, available watt capacity is written to memory as at 134.

The subroutine for the measure temperature step 186 of the main program is shown in FIG. 9 and commences by sampling the output from a temperature sensor (not shown) at step 200 to determine whether temperature is less than a user-set temperature limit, in which case a fan (not shown in FIG. 9) is switched on as at 202. Temperature is again compared to the user-selected operating limit at step 204 and if the temperature is less than that operating parameter, the routine returns to the main program. If measured temperature is not less than the user-selected operating parameter, an alert 206 is sent to the coordinator. If the measured temperature is below the user-selected temperature limit, the fan is switched off 208 and the routine returns to the main program.

Referring now to FIG. 10, the control logic for the group affiliation subroutine is shown in more detail than is shown at 128 in FIG. 8. At step 250, the switch controller 28 is queried to determine whether the controller is set in repeat “R” mode; if so, the routine is exited through the toggle relays routine 180 and back to the main program. If not in repeat mode, the controller is queried at 254 for a read command “C” at a specific memory address, and if the “C” command is present, the controller reads the informed memory address as at 256, then exits through toggle relays routine 180 to the main program. If no “C” command is read, the routine next checks for a set “S” command and the above-described “FF” command at step 258. If commands “S” and “FF” are received, current operating status is recorded at the informed memory address at step 260 and the routine exits to the main program. If both commands “S” and “FF” are not received, the system checks to see if “S” and “0F” commands are received at step 262 and, if not, the routine exits to the main program. If both “S” and “0F” commands are read at step 262, the controller next checks for the presence of a “flag” previously established by IR command. If “flag” not present, the default “FF” is recorded at the informed memory address at step 266 and the routine exits to the main program.

Those skilled in the art who have the benefit of this disclosure will recognize that changes can be made in the specifics of the operation of the present invention that do not change the manner in which the objects and advantages of the invention as described herein are accomplished. All such changes are intended to fall within the scope of the following, non-limiting claims.

What is claimed is:

1. Apparatus for controlling multiple electrical appliances in a network comprising:
a switch controller mounted to a each electrical appliance in the network;
a transceiver connected to each said switch controller for (a) transmitting a signal to said switch controller for operating each electrical appliance when said transceiver receives an external input and (b) producing a signal indicative of the operating status of each electrical appliance;
operating logic stored in the memory of said switch controller comprising a set of pre-programmed operating rules for either switching each electrical appliance on, switching each electrical appliance off, or not switching each electrical appliance upon receipt of a signal from said receiver; and
a system coordinator for sending and receiving signals from said transceiver in accordance with a set of pre-programmed operating rules stored in the memory thereof, said pre-programmed operating rules being responsive to one or more of (a) each of the electrical appliances, (b) the energy usage of each of the electrical appliances, or (c) the energy available for operating each of the electrical appliances.

2. The apparatus of claim 1 additionally comprising operating logic stored in the memory of said switch controller for switching each of the electrical appliances on or off in accordance with the external input.

3. The apparatus of claim 2 additionally comprising one or more of a cooling fan, a motion sensor, or an ambient light sensor and operating logic stored in the memory of said switch controller for switching each of the electrical appliances on or off in accordance with the external input.

4. The apparatus of claim 3 wherein said system coordinator sends a signal causing the switch controller of each of the electrical appliances to ignore an external input.

5. The apparatus of claim 1 further comprising apparatus for producing either an infrared or a laser output and a detector providing an input to said switch controller for switching one or more of the electrical appliances controlled by said system coordinator on or off, said transceiver producing a signal indicative of a change in the operating status of the electrical appliance at which the infrared or laser output is detected.

6. The apparatus of claim 5 wherein a signal indicative of a change in the operating status of the electrical appliances at which the infrared or laser output is detected is received by said system coordinator and either stored to memory or effects a change in the operational state of the electrical appliances other than the electrical appliance that detected the infrared or laser output.

7. The apparatus of claim 1 further comprising a pre-programmed operating rule for returning each of the electrical appliances to the operational status of each electrical appliance at an operator-selected point in time.

8. A method of allocating energy usage in a network including multiple electrical appliances, a controller for switching each electrical appliance on and/or off, a system coordinator having a set of pre-programmed operating rules stored in the memory thereof, and means for communicating between the system coordinator and the switch controller comprising the steps of:
(a) setting a limit on the energy usage by the electrical appliances in the network;
(b) switching each electrical appliance on and/or off in accordance with the needs of the network;
(c) communicating the operating status of each of the electrical appliances to the system coordinator;
(d) comparing the energy usage of the electrical appliances in the network to the energy usage limit;
(e) if energy usage exceeds the energy usage limit, switching electrical appliances in the network off to decrease energy usage;
(f) repeating steps (b)-(e) until energy usage is lower than the limit set in step (a); and
(g) storing the operating status of each of the electrical appliances in the network to a look-up table in the memory of the system coordinator for subsequent retrieval and use in limiting energy usage of the network.

9. The method of claim 8 additionally comprising detecting a dynamic input at one or more of the electrical appliances and communicating the dynamic input to the system coordinator, the operating rules stored in the memory of the system coordinator operating to either switch one or more of the electrical appliances on, switch one or more of the electrical appliances off, or to not switch one or more of the electrical appliances on or off.

10. The method of claim 8 further comprising the step of (h) changing the pre-programmed operating rules in accordance with a change in the limit on the energy usage of the electrical appliances in the network.

11. The method of claim 10 further comprising repeating steps (b)-(e) until energy usage is lower than the limit set in step (h).

12. The method of claim 8 wherein one or more of the electrical appliances in the network is manually set to a desired operating state, the operating status of the manually set electrical appliances is communicated to the system coordinator and stored in the memory of the system coordinator, and other electrical appliances in the network are subsequently switched on and/or off in accordance with the pre-programmed operating rules.

13. A method of operating multiple electrical appliances in a network comprising the steps of:
sending a signal to a switch controller mounted to each of the electrical appliances in the network to switch each electrical appliance to a desired operating state;
producing a signal indicative of the operating state of each of the electrical appliance;
storing the operating state of each of the electrical appliances in the network to memory; and
assigning a control command to the stored operating state of each of the electrical appliances in the network for subsequent retrieval for returning each of the electrical appliances to the stored operating state.

14. The method of claim 13 wherein the electrical appliances return to the stored operating state upon receipt of a broadcast command.

15. The method of claim 14 wherein the command is broadcast to the switch controller on each electrical appliance in the network by a system coordinator.

16. The method of claim 13 additionally comprising either switching one or more of the electrical appliances on, switching one or more of the electrical appliances off, or not switching one or more of the electrical appliances on or off upon receipt of a signal from an external input in accordance with a set of pre-programmed operating rules stored in the memory of a system coordinator communicating with the electrical appliances in the network.

17. The method of claim 16 wherein the pre-programmed operating rules stored in the memory of the system coordinator are responsive to one or more of (a) the electrical appliances in the network, (b) the energy usage of the electrical appliances in the network, or (c) the energy available for operating the electrical appliances in the network.

18. The method of claim 16 wherein the signal from an external input is generated by one or more of a transmitter for controlling individual appliances in the network, an ambient light sensor, a temperature sensor, or a motion sensor.

19. A method of grouping one or more of the electrical appliances in a network for subsequent switching of the electrical appliances on or off with a single broadcast command comprising the steps of setting each electrical appliance in a network to a desired operating state, alerting selected electrical appliances in the network to receive a flag command, the flag command causing each alerted electrical appliance to record current operating state to an informed memory location, and then, upon receipt of a subsequent command broadcast to the appliances in the network, to read the informed memory location for either maintaining current operating state or switching on or off as instructed by the data stored at the informed memory location.

20. The method of claim 19 wherein the subsequent command is broadcast from a system coordinator to switch controllers located on each of the electrical appliances in the network.
